(19) United States
(12) Patent Application Publication
(10) Pub. No.: US 2005/0045741 A1
(43) Pub. Date: Mar. 3, 2005

(54) Nozzle spray tip

(76) Inventor: Daniel P. Brown, Palos Park, IL (US)

Correspondence Address: QUARLES & BRADY LLP, 411 E. WISCONSIN AVENUE, SUITE 2040, MILWAUKEE, WI, 53202-4497, US

(21) Appl. No.: 10/649,142

(22) Filed: Aug. 27, 2003

(51) Int. Cl. B05B 7/30

(52) U.S. Cl. 239/318

(57) ABSTRACT

A fluid dispensing spray tip suitable for spraying a high density foam includes a body defining a passageway therethrough. The passageway has an inlet for receiving a pressurized fluid and terminates in a reservoir. The reservoir intersects a V-groove formed through at least one wall of the body and forms an elongated aperture for dispensing the fluid therethrough.

### CROSS REFERENCES TO RELATED APPLICATIONS

This application is a continuation-in-part of U.S. patent application entitled “MULTI-COMPONENT FLUID NOZZLE ASSEMBLY WITH DETACHABLE NOZZLE SPRAY TIP” filed on Aug. 11, 2003 and assigned Attorney Docket No. 790380.00003.

### STATEMENT REGARDING FEDERALLY SPONSORED RESEARCH

Not Applicable

### TECHNICAL FIELD

This invention relates to fluid dispensing devices, and more particularly to a spray tip for use with a fluid dispensing device that can be used to spray a high density fluid in spray pattern.

### DESCRIPTION OF THE BACKGROUND ART

Manually operable guns are known for dispensing a settable urethane foam. Separate fluid components are fed individually to the gun, passed separately through control valves, and brought into contact with each other upon reaching a mixing chamber of a nozzle from which the mixed components are discharged as foam. Examples of such guns are found in U.S. Pat. Nos. 4,311,254 and 4,399,930 issued to Gary Harding and in U.S. Pat. No. 4,762,253 issued to Steven Palmert.

The two fluid components are commonly referred to as the “A resin” and the “B resin”. They usually consist of polymeric isocyanate and polyol amine, respectively. The components are supplied separately in two pressurized containers that are attached by hoses to inlets to the guns. The foam components are typically sold to provide foams having a density ranging between 1.0 to 4 lbs/ft³.

When the two fluid components or resins are mixed, the mixture quickly sets up to form a rigid foam product which is substantially insoluble and extremely difficult to remove from surfaces with which it comes in contact. As a result, the nozzles for the guns in which the two components are first mixed are typically designed to be replaceable and disposable so as to avoid the necessity for cleaning the nozzles.

There are a variety of nozzles available that can produce different spray patterns. The spray pattern is affected by the density of the foam being sprayed. Foam having a density of less than 2.5 lbs/ft³ can typically be dispensed through known nozzles to provide a satisfactory spray pattern. It is difficult, however, to achieve a satisfactory spray pattern (i.e. a spray pattern that sprays a uniform area) when dispensing higher density foams (i.e. foams having a density of at least 2.5 lbs/ft³) through known nozzles having a typical spray tip.

A typical nozzle and spray tip dispenses foam through an orifice. Foam having a density less than 2.5 lbs/ft³ is typically expelled through a variety of orifices to form a spray pattern that can cover a large vertical area. Accordingly, the ability to spray a lower density foam through an orifice is known in the art. Under the same pressure, higher density foam, however, tends to exhaust from the orifice in a thick fire hose pattern which is only suitable for shooting foam into a hole or cavity. As a result, when spraying the higher density foam on a vertical surface, it is difficult to impossible to achieve an effective pattern. Therefore, a need exists for a nozzle spray tip that can produce a satisfactory spray pattern using a range of foam densities, including higher density foams.

### SUMMARY OF THE INVENTION

The present invention provides a fluid dispensing spray tip suitable for spraying a high density foam. The spray tip includes a body defining a passageway therethrough. The passageway has an inlet for receiving a pressurized fluid and terminates in a reservoir. The reservoir intersects a V-groove formed through at least one wall of the body and forms an elongated aperture for dispensing the fluid therethrough.

A general objective of the present invention is to provide a spray tip that can spray fluids of different densities in a known spray pattern. This objective is accomplished by provided a spray tip having a body including a reservoir intersected by a V-groove formed through a wall of the body to form an elongated aperture for dispensing the fluid therethrough.

Another objective of the present invention is to control the spread of foam expelled through a spray trip to further define the spray pattern. This objective is accomplished by providing shaping lips downstream of the elongated aperture to further define the spray pattern of the dispensed fluid.

The foregoing and other objectives and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF SUMMARY OF THE DRAWINGS

FIG. 1 is a view in elevation of a foam dispensing gun in accordance with the present invention;

FIG. 2 is a view in horizontal section taken in the plane of the line 2—2 of FIG. 1;

FIG. 3 is a detailed partial view in vertical section taken in the plane of the line 3-3 in FIG. 2 showing the valve members in an open position;

FIG. 4 is a top view of the nozzle of FIG. 1;

FIG. 5 is a front view of the nozzle of FIG. 4;

FIG. 6 is a sectional view along line 6-6 of FIG. 5;

FIG. 7 is a detailed sectional view along line 7-7 of FIG. 6;

FIG. 8 is a spray pattern of a prior art nozzle;

FIG. 9 is a view of the spray pattern along line 9-9 of FIG. 8;

FIG. 10 is a spray pattern of a nozzle incorporating the present invention;

FIG. 11 is a view of the spray pattern along line 10-10 of FIG. 10;

FIG. 12 is a table showing spray tips incorporating the present invention having different combinations of tip entrance diameters and front spray face angles;

FIG. 13 is a view in elevation of another embodiment of a foam dispensing gun having a external threads for detachably fixing a detachable spray tip in accordance with the present invention;

FIG. 14 is a top view of a detachable spray tip for detachably fixing to the gun of FIG. 13;

FIG. 15 is a front view of the nozzle of FIG. 14;

FIG. 16 is a side view of the spray tip of FIG. 14; and

FIG. 17 is a sectional view along line 17-17 of FIG. 16.

### DETAILED DESCRIPTION OF THE PREFERRED EMBODIMENTS

The foam dispensing gun disclosed herein is substantially identical to the foam dispensing gun disclosed in U.S. Pat. No. 5,462,204 with the exception that it includes, as described below, a spray tip for producing a desired fan spray pattern when spraying a high density foam. U.S. Pat. No. 5,462,204 is assigned to the assignee of the present invention, and is fully incorporated herein by reference.

References to foam and foam components, herein, encompass any multi-component and single components fluids, such as a settable urethane foam, epoxy, silicone, and the like. In addition, although the multi-component foam dispensing gun disclosed herein is preferred, fluid dispensing gun having a spray tip, as disclosed herein, without departing from the scope of the invention.

Referring to FIGS. 1-3, in general, the foam dispensing gun includes a body 10 with a handle 11 that may be formed integral with the body 10. The body 10 and handle 11 may be molded from a synthetic resin material. The body 10 is formed with a pair of longitudinal, parallel passageways 12 and 13. The passageways 12 and 13 are divided into forward and rearward portions by an intermediate chamber 14. The rearward portions of the passageways 12 and 13 mount brass connectors 15 that have a ribbed end for attachment to hoses connected to pressurized containers for fluid components that are used to form the foam.

The connectors 15 are hollow and define passageway inlets leading from the tanks of components. The bushings 22 are also hollow and mount duck-bill valves 25 in their center. The duck-bill valves 25 are formed of a rubber or other elastomeric material and function as one-way valves to permit fluid under pressure to enter a passageway 12 or 13.

Each bushing 22 is disposed against a bellville spring 26 which bears against an end of the respective connector 15 thereby urging the bushing 22 inwardly in the passageway 12 or 13 until it abuts against a shoulder 27. A coiled spring 30 is disposed in each of the passageways 12 and 13. The spring 30 bears at one end against an end of a respective bushing 22. The other ends of the springs 30 bear against the ends of brass needle valve members 31 also disposed in the passageways 12 and 13.

The needle valve members 31 span the chamber 14 and are received in both the forward and rearward portions of the passageways 12 and 13. The needle valve members 31 have a rear portion provided with a radial recess 32 that mounts an O-ring 33 to seal with the rearward portion of the passageway 12 or 13. The forward portion of each valve member 31 is formed as a conical needle valve portion 35 terminating in a circular cylindrical tip 36. The conical needle valve portion 35 and tip 36 mate with a conical valve seat 37 having a circular cylindrical extension 38 and formed in the body 10 at the front terminus of the passageways 12 and 13.

The valve seats 37 define passageway outlets, and open directly through the front face of a nose 40 on the body 10. The valve members 31 have an annular recess 39 behind the conical needle valve portion 35. The recess 39 mounts an O-ring 41 that seals the junction of the needle valve portion 35 and the conical valve seat 37 when the valve is closed, as shown in FIG. 2. The valve members 31 have an additional annular recess 45 that mounts an O-ring 46 that seals with the forward portions of the passageways 12 and 13.

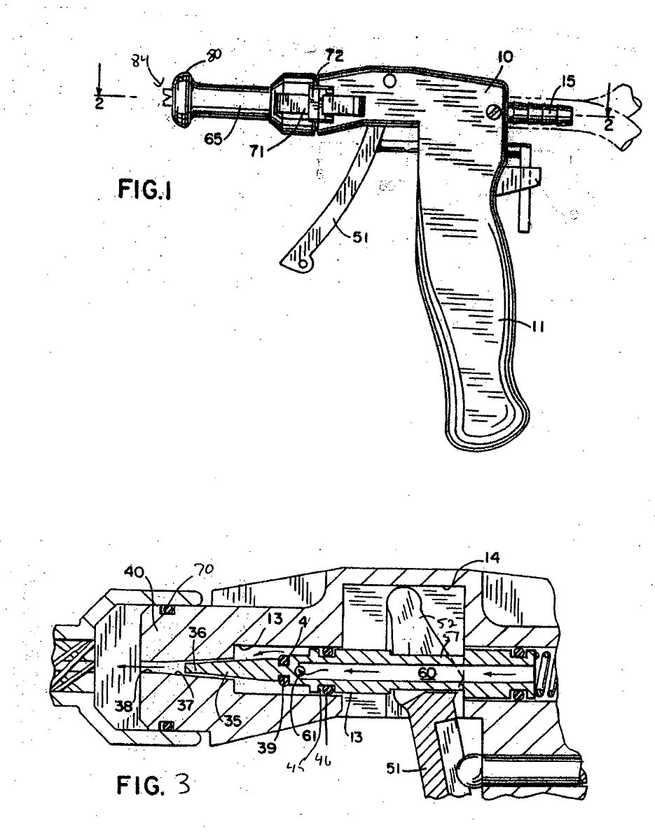

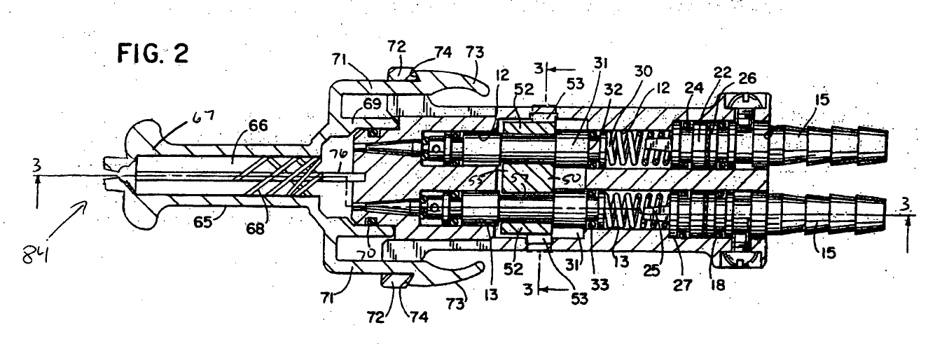

The chamber 14 mounts a yoke 50 formed at the top of a trigger lever 51. The yoke 50 has a pair of arms 52 terminating in lateral bosses 53 that are received for pivotal movement in holes 54 in the two sides of the body 10, as shown in FIG. 3. The yoke 50 also includes a central rib 55 which, with the arms 52, defines two spaced cradles 56 that receive necked down portions 57 intermediate the ends of the valve members 31. The springs 30 normally urge the valve members 31 forwardly to close the needle valves 35 against the valve seats 37. The trigger lever 51 can be rotated to withdraw the valve members 31 against the urgings of the springs 30 to open the valves.

Each valve member 31 has a central internal passage 60 that terminates in a transverse port 61 that extends to the surface of the valve member at a point between the O-rings 40 and 46. As shown in FIG. 3, when the trigger lever 51 is squeezed to open the valves, fluid from the pressurized containers can pass through the central passages 60 in the valve members 31, out the ports 61, through the valve seats 37, and out of the front nose 40 of the body 10. The O-rings 46 prevent fluid from moving rearwardly along the passageways 12 or 13. As the valves are closed, the conical needle valve portions will extrude materials forwardly out of the valve seats. The seating of the needle valve in the valve seat combined with the O-rings 40 will seal off the interior of the passageways and prevent air from reaching the fluid resins in such passageways.

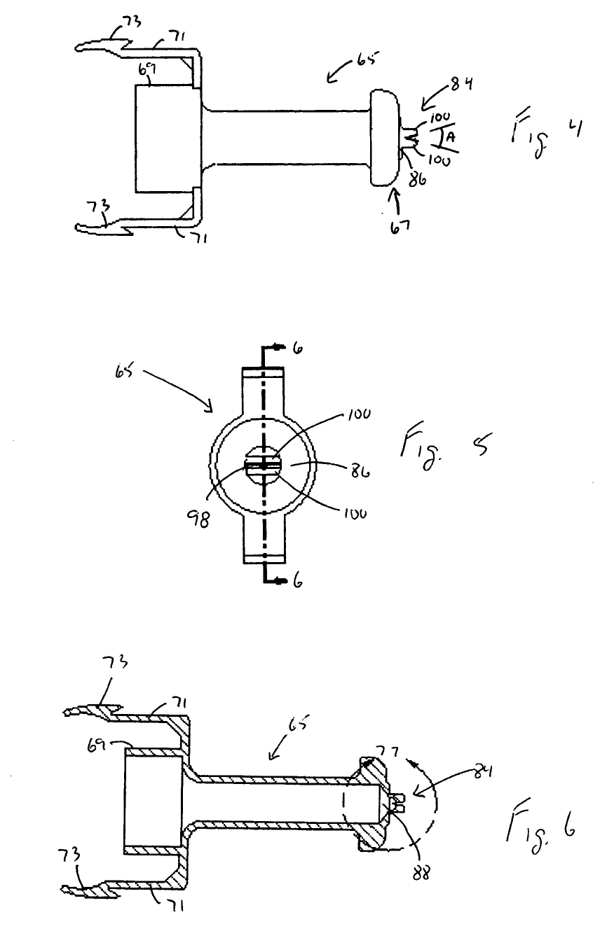

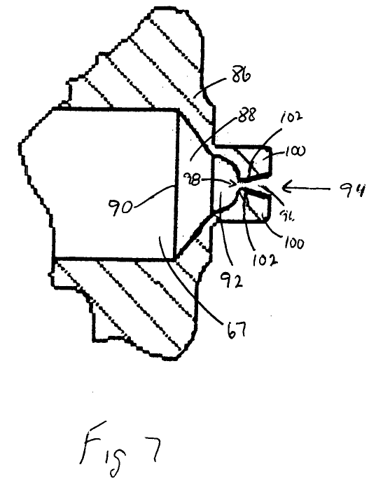

Referring to FIGS. 2-6, a disposable nozzle 65 is mounted on the front of the gun 10. The nozzle 65 has a hollow interior that defines a mixing chamber 66 interposed between an inlet chamber and an outlet 67. A helical static mixer 68 of known construction is mounted in the mixing chamber 66. The rear end of the nozzle 65 upstream of the mixing chamber 66 has an enlarged circular cylindrical portion 69 which surrounds the nose 40 of the body 10 and is sealed thereto by an O-ring 70. The cylindrical portion 69 also defines the open inlet chamber. An annular ring 80 formed around the nozzle 65 proximal the outlet 67 provides grasping surfaces for securely grasping the nozzle 65 when attaching and detaching the nozzle 65 from the gun body 10.

A pair of resilient arms 71 extend along either side of the nozzle rearwardly from the enlarged cylindrical portion 69. The resilient arms 71 are adapted to engage ears 72 that extend from opposite sides of the body 10 adjacent the nose 40. The resilient arms 71 have a curved portion 73 adjacent their ends which terminates in a notch 74 that mates with an ear 72. The nozzle can be quickly attached to the body 10 by sliding the resilient arms 71 beneath the ears 72. The curved portions 73 will cam the arms 71 so that the arms will slide easily past the ears 72 until the notches 74 engages with the ears 72. The nozzles 65 can be easily removed by manually depressing the curved ends 73 of the arms 71 to release the notches 74 from the ears 72 and allow the arms 71 to slide past the ears 72. Although detachably fixing the nozzle to the body is preferred, as described above, the nozzle can form an integral and/or permanent part of the body, or be detachably fixed to the body using other methods, such as by using a threaded engagement, snap fit, friction fit, fasteners, and the like, without departing from the scope of the invention.

The static mixer 68 includes a wall portion 76 which is located in the open inlet chamber defined by the enlarged cylindrical end 69 of the nozzle. As shown in FIG. 2, the wall portion 76 divides the inlet chamber and is positioned between the valve seats 37 so that complete mixing of the two fluid components does not occur immediately at the nose 40. If the nozzle 65 should become clogged with foam and not be replaced, the subsequent opening of the valves could result in the fluid of higher pressure being forced from the mixing chamber through the valve seat for the other component in the reverse direction. The duckbill valves 25 prevent such cross-contamination which would result in set-up of the components within the gun if allowed to occur. Although a static mixer is shown, the nozzle can have other types of mixers, such as a dynamic mixer, or the nozzle can be provided without a mixer, without departing from the scope of the invention.

The nozzle 65 dispenses the mixed foam components through a spray tip 84 disposed at the nozzle outlet 67. The spray tip 84 includes a body 86 having a hollow interior 88 defining a passageway therethrough, The passageway includes a spray tip inlet 90 in fluid communication with the nozzle hollow interior, and terminates in a reservoir 92 in fluid communication with a spray tip outlet 94. Fluid flowing through the spray tip passageway enters through the spray tip inlet 90 and flows into the reservoir 92 prior to exiting through the spray tip outlet 94.

The reservoir 92 is formed in the body 86 of the spray tip 84, and preferably has a concave semi-spherical shape that guides the fluid toward the spray tip outlet 94. The diameter of the semi-spherical shape is referred to as a tip entrance diameter, and is preferably between about 0.10 and 2.5 inches. The preferred tip diameter, however, is dependent upon the foam density, material output, and desired spray pattern, and thus can fall outside of the preferred tip diameter range disclosed herein.

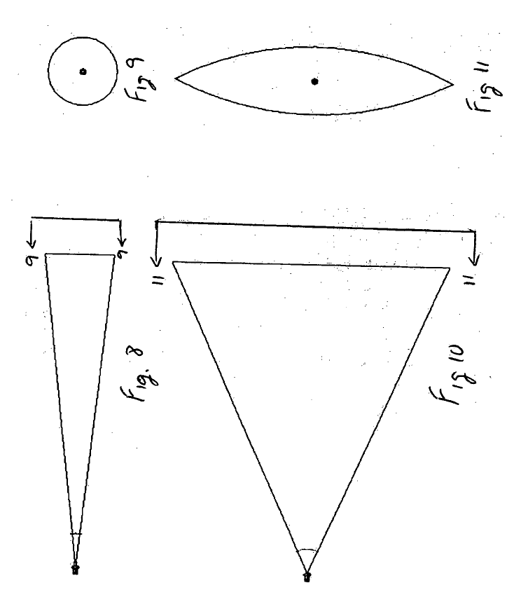

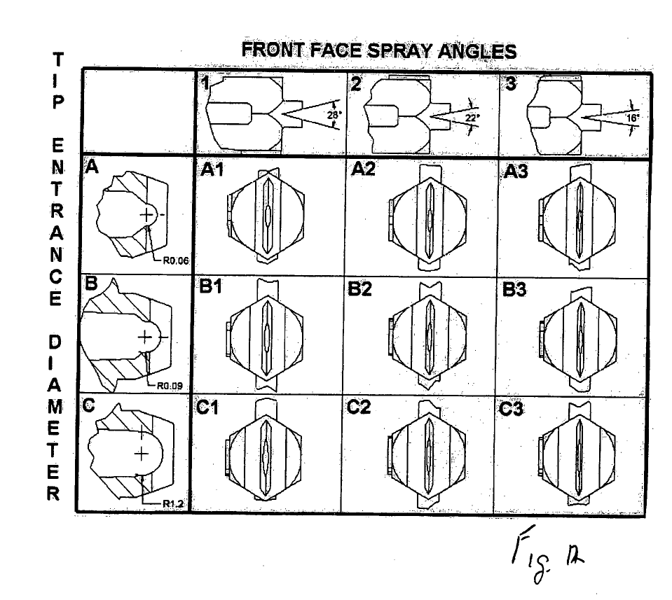

A V-groove 96 formed in the spray tip body 86 intersects the reservoir 92 to form an elongated aperture 98 that defines the spray tip outlet 94. The elongated aperture 98 provides a flattened fan spray pattern, such as shown in FIGS. 10 and 11, compared to a conical flow pattern, such as shown in FIGS. 8 and 9, produced by a prior art spray tip having an orifice. Preferably, the V-groove 96 is defined by an angle A which can range between about 15° and 30° to produce the desired fan spray pattern. Of course, the V-groove angle A can be less than 15° or greater than 30° depending upon the desired fan spray pattern. As the V-groove angle decreases, the spread of the fan spray narrows.

Different combinations of V-groove angles and tip entrance diameters can be provided without departing from the scope of the invention, and depend upon the desired spray pattern and foam density. For example, in the table disclosed in FIG. 12, different combinations of tip entrance diameters and V-groove angles, also referred to as front face spray angles, are disclosed.

Diverging shaping lips 100 extend from elongated edges 102 of the aperture 98 to further shape and limit the spray pattern spread of the fluid exhausting through the spray tip outlet 94 to maintain a desired foam density on the object being sprayed. Of course, the foam density is also affected by many other factors, such as formulation, fluid pressure, distance from the object being sprayed, and the like. Preferably, the lips 100 diverge at an angle equal to the V-groove angle to form a pair of continuous diverging walls extending from the reservoir 92. The lips 100, however, can diverge at an angle different from the V-groove angle without departing from the scope of the invention. Although lips 100 jutting out from the spray tip body 86 are shown, the lips 100 can be formed as part of a V-groove 96 extending deep into the body 86 and intersecting with the reservoir 92 to form the aperture 98, without departing from the scope of the invention.

The spray tip 84 is especially suited for spraying a high density foam (i.e. a foam having a density of at least 2.5 lbs/ft³) in a fan spray pattern. The reservoir 92 maintains a supply of pressurized foam upstream of the elongated aperture which restricts the high density foam in one dimension to form the fan spray pattern. The shaping lips 100 maintain the fan spray pattern by controlling the foam expansion immediately downstream of the aperture. Of course, the spray tip 84 can used with foams having a density less than 2.5 bs/ft³ without departing from the scope of the invention.

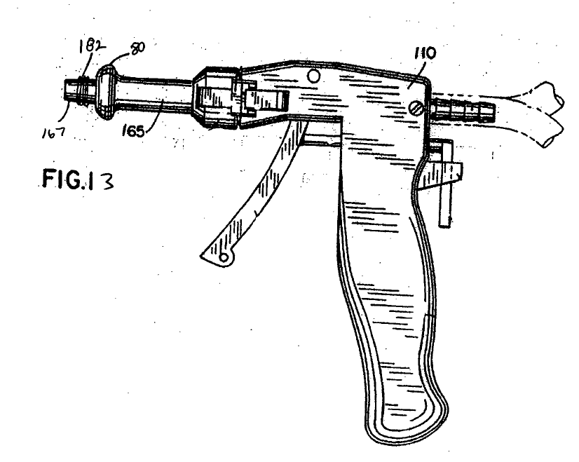

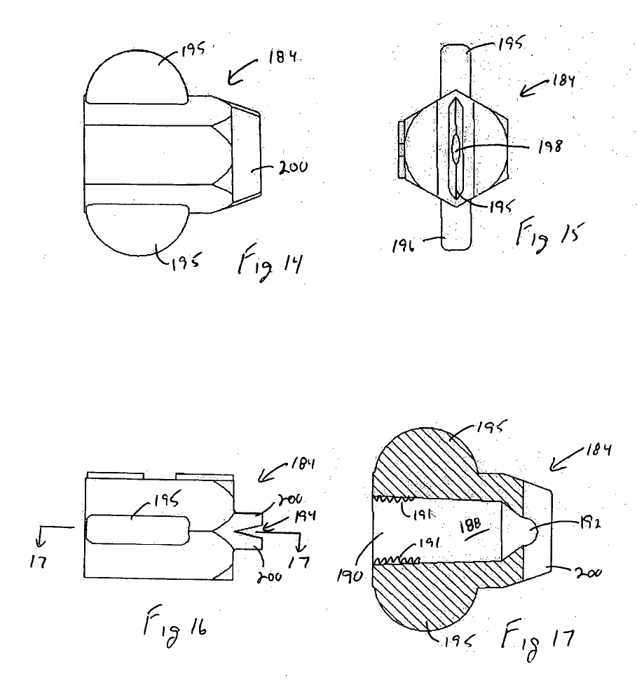

In an alternative embodiment shown in FIGS. 13-17, a spray tip 184 is detachably fixable to a foam dispensing gun 110. The spray tip 184 includes a body 186 having a hollow interior 188 defining a passageway therethrough, The passageway includes a spray tip inlet 190 in fluid communication with the nozzle hollow interior, and terminates in a reservoir 192 in fluid communication with a spray tip outlet 194. Fluid flowing through the spray tip passageway enters through the spray tip inlet 190 and flows into the reservoir 192 prior to exiting through the spray tip outlet 194. Internal threads 191 are formed in the body for threadably engaging a nozzle 186 forming part of the gun 110. A V-groove 196 intersects the reservoir 192 to form an aperture 198 defining the spray tip outlet 194. As disclosed above, shaping lips 200 can be provided to further shape the spray pattern of the fluid.

The gun 110 includes the nozzle 165 having a nozzle outlet 167 with external threads 182. The spray tip inlet internal threads 191 threadably engage the external threads 182 to detachably fix the spray tip 184 to the nozzle 165, such as disclosed in copending U.S. patent application entitled “MULTI-COMPONENT FLUID NOZZLE ASSEMBLY WITH DETACHABLE NOZZLE SPRAY TIP”, filed on Aug. 11, 2003, assigned Attorney Docket No. 790380.00002, and fully incorporated herein by reference. Of course, other means for detachably fixing the spray tip 184 to the nozzle outlet 167, such as a twist lock engagement, friction fit, snap fit, and the like, can be used without departing from the scope of the invention. Moreover, fasteners, such as set screws, hose clamps, bands, and the like, can be used to more securely fix the spray tip to the nozzle outlet end.

Opposing wings 195 extending radially from the detachable spray tip 184 provide engagement surfaces for rotating the spray tip 84 to threadably engage the internal threads 191 with the external threads 182. Of course, other means can be provided for securely grasping the spray tip to detachably fix the spray tip to the nozzle end, such as a single wing, a knurled exterior surface, a geometric external cross section for engaging a wrench, and the like, without departing from the scope of the invention.

While there has been shown and described what is at present considered the preferred embodiment of the invention, it will be obvious to those skilled in the art that various changes and modifications can be made therein without departing from the scope of the invention defined by the appended claims.

1. A fluid dispensing spray tip comprising:
a body defining a passageway for a fluid, said passageway including an inlet and terminating in a concave semispherical reservoir; and
a V-groove formed in said body and intersecting said reservoir to form an elongated aperture for dispensing the fluid therethrough.

2. The fluid dispensing spray tip as in claim 1, in which a pair of diverging shaping lips extend from said aperture and shape the fluid dispensed through said aperture.

3. The fluid dispensing spray tip as in claim 2, in which said pair of diverging lips are aligned with said V-groove to form a pair of continuous diverging walls extending from said semispherical surface.

4. The fluid dispensing spray tip as in claim 1, in which said V-groove defines a V-angle of about between 15° and 30°.

5. The fluid dispensing spray tip as in claim 1, in which said passageway inlet is in fluid communication with a nozzle outlet.

6. The fluid dispensing spray tip as in claim 5, in which said body is detachably fixed to a nozzle.

7. The fluid dispensing spray tip as in claim 1, in which said body is formed as an integral part of a nozzle.

8. A fluid dispensing spray tip comprising:
a body defining a passageway therethrough, said passageway having an inlet for receiving a pressurized fluid and terminating in a reservoir, said reservoir intersecting a V-groove formed in said body and forming an elongated aperture for dispensing the fluid therethrough.

9. The fluid dispensing spray tip as in claim 8, in which said reservoir includes a concave semispherical surface formed at an end of said passageway in said body, and said semispherical surface intersects said V-groove formed in said body to form said elongated aperture for dispensing the fluid therethrough.

10. The fluid dispensing spray tip as in claim 8, in which a pair of diverging shaping lips extend from said aperture and shape the fluid dispended through said aperture.

11. The fluid dispensing spray tip as in claim 10, in which said pair of diverging lips are aligned with said V-groove to form a pair of continuous diverging walls extending from said semispherical surface.

12. The fluid dispensing spray tip as in claim 8, in which said V-groove defines a V-angle of about between 15° and 30°.

13. The fluid dispensing spray tip as in claim 8, in which said passageway is in fluid communication with a nozzle outlet.

14. The fluid dispensing spray tip as in claim 8, in which said body is detachably fixed to a nozzle.

15. The fluid dispensing spray tip as in claim 8, in which said body is formed as an integral part of a nozzle.

16. A fluid dispensing spray tip comprising:
a body defining a passageway therethrough, said passageway having an inlet for receiving a pressurized fluid and terminating in a reservoir, said reservoir intersecting a V-groove formed in said body and forming an elongated aperture for dispensing the fluid therethrough; and
a pair of diverging shaping lips extending from said aperture and shaping the fluid dispensed through said aperture, said pair of diverging lips being aligned with said V-groove to form a pair of continuous diverging walls extending from said reservoir.

17. The fluid dispensing spray tip as in claim 16, in which said reservoir includes a concave semispherical surface formed at an end of said passageway in said body, and said semispherical surface intersects said V-groove to form said elongated aperture for dispensing the fluid therethrough.

18. The fluid dispensing spray tip as in claim 16, in which said V-groove defines a V-angle of about between 15° and 30°.

19. The fluid dispensing spray tip as in claim 16, in which said passageway is in fluid communication with a nozzle outlet.

20. The fluid dispensing spray tip as in claim 16, in which said body is detachably fixed to a nozzle.

21. The fluid dispensing spray tip as in claim 16, in which said body is formed as an integral part of a nozzle.
